(19) United States
(12) Patent Application Publication
(10) Pub. No.: US 2006/0074904 A1
(43) Pub. Date: Apr. 6, 2006

(54) Content delivery rendering engine

(76) Inventors: Ajay M. Mungara, Hillsboro, OR (US); Vaughn H. Hughes, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/956,999

(22) Filed: Sep. 30, 2004

(51) Int. Cl. G06F 17/30

(52) U.S. Cl. 707/5

(57) ABSTRACT

A method and apparatus for a content delivery rendering engine. An embodiment of a method includes establishing a matching rule for generation of a web page; receiving a request for the web page; obtaining content for the web page from a database, with the content for the web page being based at least in part on the matching rule; and generating the web page, the web page including the content obtained from the database.

### FIELD

An embodiment of the invention relates to information services in general, and more specifically to a content delivery rendering engine.

### BACKGROUND

Providing and delivering content for web sites are important aspects of modern communications. Numerous tools are available today for presenting content to users, which are used to provide a wide variety of information in many different forms. An organization may provide web information to audiences that include both internal and external users. The information may be wide mix of public information and sensitive internal information for a variety of different audiences, thereby creating security issues regarding the delivery of content.

However, the presentation of content data is still a time consuming and complicated process. Many choices need to be made regarding web page design and how information will be presented. Conventional web pages are static in nature. The presentation of such pages requires a great deal of attention to formatting and structure. Instituting a change in a conventional web site can require modifications of many web pages.

Further, in the production of content for conventional web pages, authors are concerned not only about the content of a document, but also about issues such as the look and feel of the content as presented and where the document will be presented. In a conventional web site, such decisions regarding the presentation of a document in a web site are intertwined with the management of the content. This close connection between the management of content data and the presentation of the content data may create a complex and burdensome web system.

### BRIEF DESCRIPTION OF THE DRAWINGS

The invention may be best understood by referring to the following description and accompanying drawings that are used to illustrate embodiments of the invention. In the drawings:

FIG. 1 illustrates an embodiment of content delivery;

FIG. 2 is an illustration of an embodiment of a content delivery system;

FIG. 3 is an illustration of an embodiment of a dynamically rendered web page;

FIG. 4 provides flowcharts to illustrate processes for an embodiment of content delivery;

FIG. 5 illustrates an embodiment of the rendering of a web page; and

FIG. 6 illustrates an embodiment of a computer system.

### DETAILED DESCRIPTION

A method and apparatus are described for a content delivery rendering engine.

For the purposes of this description:

“Document” means any content or form of data. The term includes white papers, visual and audio presentations, charts, computer code, and any other type of data that may be provided to a user.

“Content delivery” means any processes in connection with the provision or deliver of data to users.

“Content management” means any processes in connection with storage and maintenance of data that is stored for the purpose of providing content to users.

Under an embodiment of the invention, a content delivery rendering engine is described. In one embodiment, an engine is utilized to provide a flexible content rendering and delivery process. In one embodiment, a content delivery engine provides for dynamic generation of web pages or other data presentations as needed.

Under an embodiment of the invention, content management for a web site is separated from content delivery for the web site. In one embodiment, a content rendering system operates independently from a content management system. In an embodiment, an author of content data is not required to specify where the content will be shown on a web site or be concerned with the look and feel of the content presentation. An embodiment of the invention allows for modifying the purpose and delivery of content in various styles and content types without modification of the content. In one embodiment of the invention, a content management system for a web service does not indicate where any particular content will be associated, how many different web sites will reuse the same content, or what different styles will be used to present the content.

In one embodiment of the invention, a content delivery engine provides content to a user by generating a presentation of relevant data, such as in the form of a web page. The content delivery engine utilizes dynamic matching to aggregate relevant content items that are available in a content management system. In an embodiment, a web page is generated based at least in part on matching rules that are established for web page generation, and is transformed utilizing templates established for the creation of the web page. In one embodiment, a configuration file is generated for the rendering of web pages for a web site. The configuration file may reflect the entire web site and is used in the collection and filtering of data and the presentation of such data in the form of web pages.

An embodiment of the invention utilizes known industry technologies such as XML (Extensible Mark-up Language), XSLT (Extensible Stylesheet Language Transformation), and web services to dynamically render content items that have been authored in any content management system. XSLT is a World Wide Web Consortium (W3C) standard for transforming XML documents into other XML documents or other formats, including formats such as HTML (Hypertext Markup Language) format for generation of a web page.

This description refers to web sites and web pages as particular examples for certain embodiments of the invention, but embodiments of the invention are not limited to these elements and are applicable to any computer data system and computer representation of data. Similarly, the description refers to XML as a language to describe and generate a web site, but embodiments of the invention apply to any other language or other tool to provide a representation of data content.

Under an embodiment of the invention, the logical structure of a web page or web site is separate from the content for the web page. In an embodiment, the author of a document is responsible only for the contents of the document and not for the presentation of the document. In one embodiment of the invention, a content author may only need to provide a document without any instructions regarding the placement and presentation of the content on a web site. In one embodiment, a content author may also specify pertinent metadata (data regarding the content data) for the document to aid in the operation of a content delivery system. In one particular example, an author may produce a white paper regarding a certain type of processor for presentation on a web site. In this example, the author will provide the document for storage in a content management system. The author or another person may provide metadata regarding the document, such as the following:
Product=Processor A
Document Type=White paper
Keywords=Processor, BUS, Chipset

In one embodiment of the invention, the creator of a web site establishes matching rules for web pages, with the rules being used to determine what content is provided in web pages. The rules may match documents on factors such as document content, date of creation or modification, security level required for viewing, type of document, identity of author, and any other factors regarding the document. The matching rules may include rules that are based on the metadata provided for documents, the document attributes, or any other source of document information. Among other elements, start and stop times may be provided, which may indicate when a document becomes available and when the availability of the document ends, or when a portion of the web site becomes available and when it ceases to be available. In one possible example, a matching rule may be intended to provide links to a certain number of recent documents that are related to a certain type of product:
(Product=“Processor A” OR “Processor B” NOT “Processor A”) AND (Keywords=“processor” OR “hardware”)
Sort by the “last modified date” and then by “user rating”
Provide the top ten items matching the criteria

In one embodiment, different types of relevant XML data, such as user data, the site context data, document metadata data, external web services data, and site configuration data, are all gathered together and sent to a transform or rendering engine for the production of web pages.

A web site generally has a certain logical navigational hierarchy, and the entire site can be specified or defined the form of an XML configuration file. In an embodiment of the invention, a configuration file defines the logical structure of a web site. In one embodiment, a configuration file includes matching rules in XML form to describe and define the process of looking up content from a database of documents. Under an embodiment of the invention, a configuration file also specifies templates, such as XSLT templates to describe how XML data can be transformed into other formats. The templates determine which applications are used to render a page. Under an embodiment of the invention, all of the factors for the rendering of web pages by a web site are defined in a single XML configuration file that describes the entire web site. In another embodiment, the configuration of a web site may utilize multiple files that operate together to define the web site.

In an embodiment of the invention, the generation of a web page is accomplished dynamically as web pages are requested. In an embodiment, a web page is not a static document that contains a predefined structure, but instead is a dynamic document that changes and varies depending on changes in the matching rules, changes in the documents, and other factors. While an embodiment of the invention provides dynamic web pages for a web site, certain web pages or certain portions of web pages may be generated based prior to the request, which may increase the speed of processing in certain cases.

In an embodiment of the invention, a document may be stored and utilized in multiple locations in a web site without duplication of the document. Once a document has been authored and stored in a content management system, the document may be used and accessed throughout the web site by the content rendering system. In one embodiment, multiple locations can utilize identical versions of document data, thereby minimizing chances of problems or confusion that might arise if a document exists in more than one version or form on a web site.

Under an embodiment of the invention, if a request for a web page is made, the content delivery engine will look up the configuration file and make a determination regarding what data it needs to build or generate the requested web page. The data includes documents that meet the requirements for the page that result from the matching rules for the web page. The collected data is compiled in XML form, and then the specified templates are utilized to generate the web page.

Under one embodiment, data used in the generation of web pages may also include other types of data, such as external data or user data (for example, the name or other information regarding the user may be incorporated dynamically into a web page). External data sources may be defined in a site configuration file, the data sources being, for example, XML web services. A content rendering engine can call out to an external data source, retrieve the data from the source, and include this data in the XML data that will be used to render the web page. In one example, an external weather or news web service may be utilized to provide data for a certain portion of a web page.

Under an embodiment of the invention, a content rendering engine provides for simple modification of a web site. The web pages are generated dynamically based upon the configuration file. If the logical structure of the site is changed, such as by adding a new section, the configuration file for the web site may be updated with the change, thereby creating a global change to the site. Upon modifying the configuration file for the web site, all portions of the site may then include links to the new section.

Under an embodiment of the invention, a content rendering engine can be used in connection with the provision of site security to ensure proper entitlement for document access. The content rendering engine may attach both permission to document and permission to whole sections of a web site. In an embodiment of the invention, a user will only see documents that are available to the user because unavailable documents will not be generated by the relevant matching rules. For example, if a matching rule limits certain documents to a particular group of users of a web site, an anonymous user will not see the documents. In this illustration, a user will only see documents that the user is entitled to see, with a web site or web page thus having a different appearance for different users based on the privileges granted to each user.

In an embodiment of the invention, various different types of templates may be used to render documents. In possible one example, web pages may be divided into content pages, which are intended to present content information, and category pages, which provide links to content or to other web pages. In this example, a first type of template (a content template) is used for content pages, such as to render a non-binary document in the form of a web page. A second type of template (a category template) is used for category pages. In this example, a third type of template (a page template) may be used for certain common portions of all web pages.

In an embodiment of the invention, more than one template may be used for the rendering of a web page. In one possible example, there is a two-step rendering process, with the first step using either a concept template or a category template to generate, for example, the central portion of a page. In a second process, a page template is used to generate the remainder of the page, for example, a header, a footer, a left-hand navigation list, or spotlight links. In this manner, the look and feel for an entire website or any portion of the site may be modified by applying modifications to the page template. The navigation and headers and footers throughout the website can be adjusted in one modification. While the described example provided for certain particular portions of a page being generated in a particular order, embodiments of the inventions may include other divisions of a web page and may be processed in any order or may be processed simultaneously in whole or in part.

In one embodiment, content transformation is a dynamic XSLT-based capability that supports multiple transforms. Content items that represent web pages do not encapsulate more than a basic document layout and formatting, such as bold and italic fonts, text paragraph alignment, simple tables, and similar features. XSLT templates then are used specify the font, colors, style, and other factors. A transform engine transforms raw aggregated XML data to HTML, XHTML (Extensible HTML), WAP (wireless application protocol) for wireless Internet access, a printer-friendly version, or other format, and provides such transformed content to a user, such as the client web browser or a consumer web service. Certain features such as DHTML (dynamic HTML) navigation flyouts, multiple language footers, content ratings, legal footers, and disclaimers may be features that are used across a web site and thus are provided globally through appropriate templates.

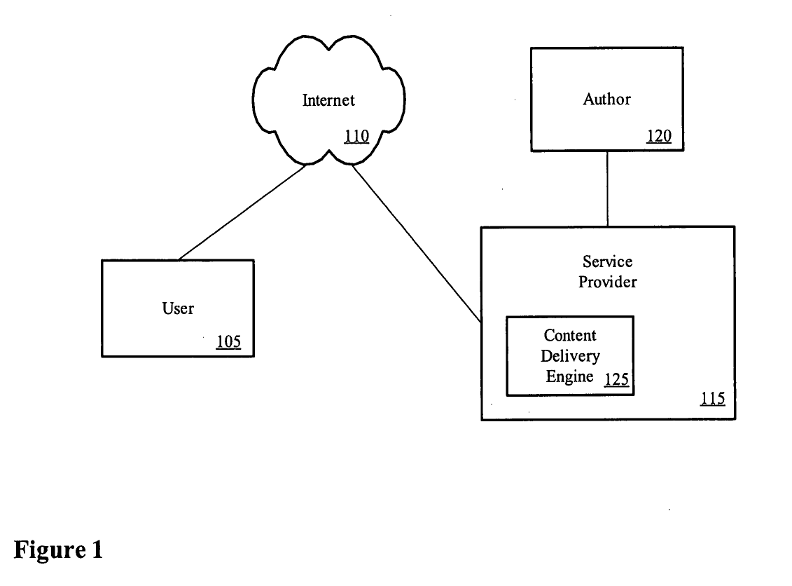

FIG. 1 illustrates an embodiment of content delivery. In one embodiment of the invention, a user 105 is connected to a network, such as the Internet 110. The user 105 is seeking to access documents or other content that are provided by a service provider 115. An author 120 creates a document and provides the document to the service provider 115. In one embodiment, the author 120 is responsible only for creating the content of the document and not with the presentation of the document. A content delivery engine 125 is used to present the document. In an embodiment of the invention, if the user 105 requests a web page that relates to the document, the content delivery engine 125 may search for and find the document, and render the document in a web format for presentation to the user 105. In an embodiment of the invention, the content delivery engine provides the document or a link to the user 105, such as in the form of a web page. In an embodiment of the invention, the content of the web page is based on matching rules established by the service provider 115.

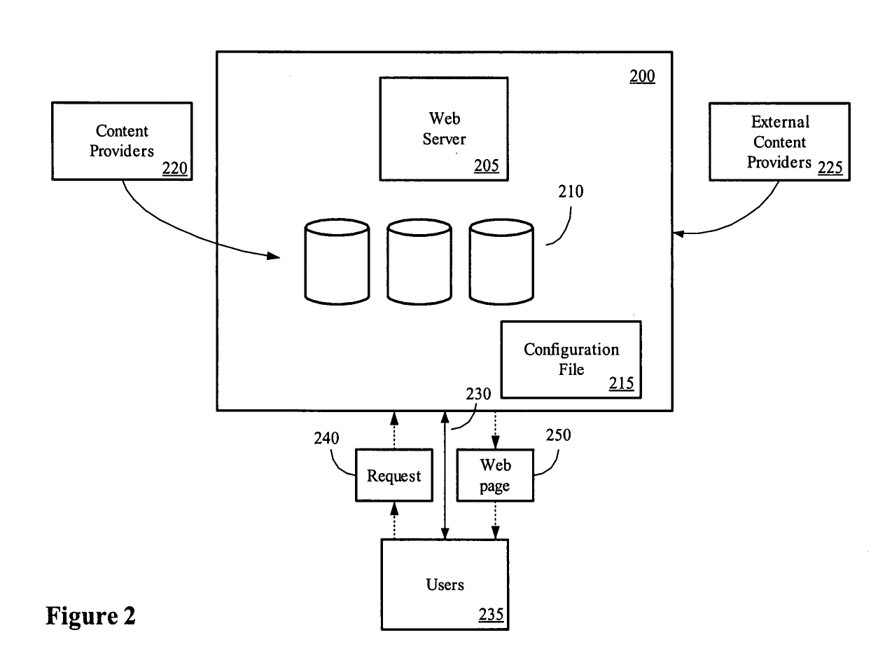

FIG. 2 is an illustration of an embodiment of a content delivery system. In this illustration, all details for operation are not provided. Other components may be included in various embodiments of the invention. In the illustrated embodiment, a system 200 includes a web server 205 to manage a web-based system. The system 200 includes one or more databases 210. In an embodiment of the invention, the databases 210 include content for delivery in web pages. In one embodiment, the documents are stored with metadata regarding the documents, such as describing the content of the document. The content may be provided by certain content providers 220. In one embodiment of the invention, the system includes a configuration file for the rendering of web pages. The configuration file 215 may include matching rules to determine the content presented in web pages and templates for use in rendering the web pages. The system 200 may also have access to data from external content providers 225.

In one embodiment of the invention, users 235 may be connected to the system via a network 230 or other connection. A user may provide a request for a web page 240. The system utilizes matching rules provided in the configuration file 215 to filter documents contained in the databases 210 to determine which documents should be presented in the requested web page. The collected data for a web page is then rendered in the form of a web page 250 using one or more templates from the configuration file.

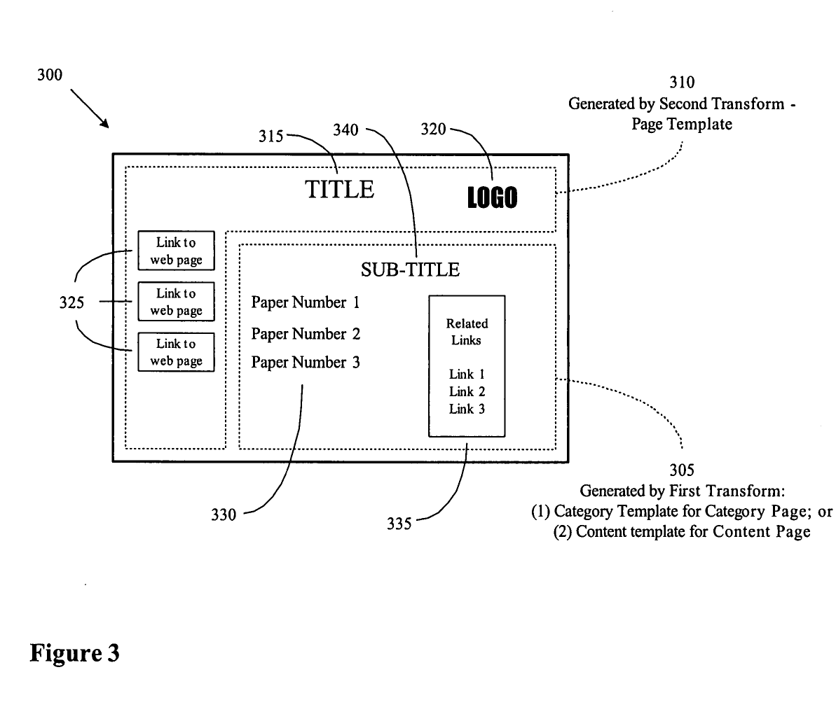

FIG. 3 is an illustration of an embodiment of a dynamically rendered web page. In this illustration, a web page is rendered dynamically in response to a request. In an embodiment of the invention, the web page 300 only contains items that a user has authority to view. Under an embodiment of the invention, the items found on the web page 300 have been filtered to limit them to relevant and current items. In this illustration, the web page is divided into a first portion 305 and a second portion 310. While this illustration contains two portions, other embodiments of the invention may include a web page that is undivided and is generated by a single transform or a web page that includes more than two portions.

In the illustrated example in FIG. 3, the first portion 305 is generated by a first transform. In one embodiment of the invention, the template used for transformation of the first portion 305 may vary depending on the type of web page generated. For example, the first portion may be transformed by a first type of template (a category template) if the web page is a page containing category or index information (a category page), or may be transformed by a second type of template (a content template) if the web page is a page containing a document or other content (a content page). The second portion 310 is generated using a third type of template for producing other portions of a page (a page template), which may represent common portions that are located on all web pages of a web site. Other types of templates may be used in other embodiments to produce other types of pages. In this example, the first portion 305 includes information that is directed to the particular web page, such a sub-title 340, links or content from certain relevant papers 330, and a list of related links 335. The second portion 310 may include common information, such as a web site or section title 315, an organizational logo 310, and a left-hand navigational listing of links to other web pages.

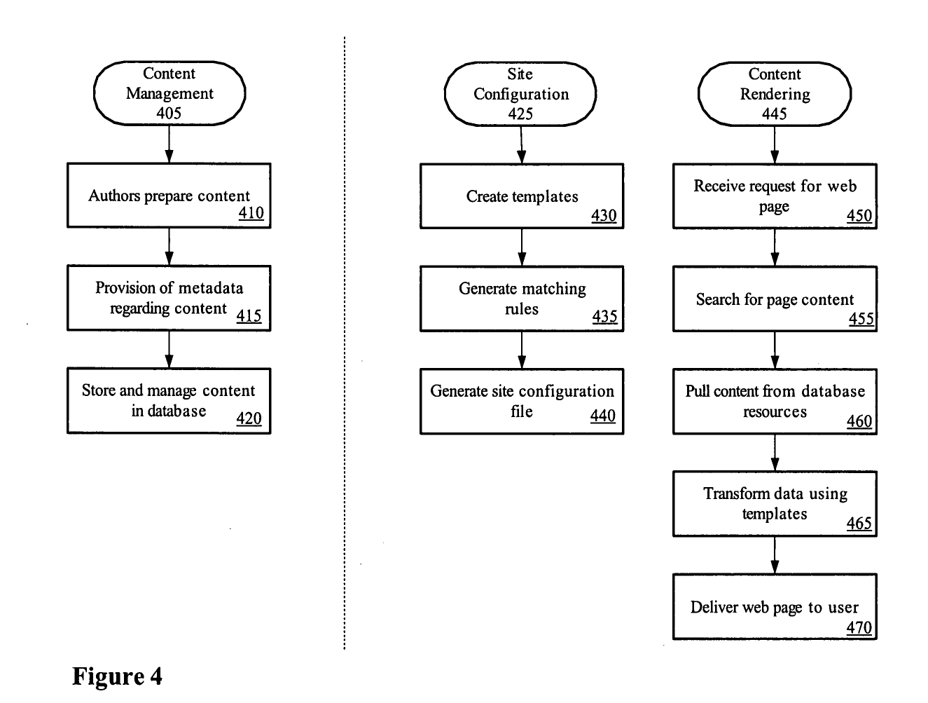

FIG. 4 provides flowcharts to illustrate processes for an embodiment of content delivery. In this illustration, three processes are shown for content management 405, site configuration 425, and content rendering 445. Under an embodiment of the invention, the management of content is separate from the configuration and content generation of site. In addition, content provided in response to a request is generated dynamically as needed. In content management 405, authors prepare the content 410, which may include writing white papers and other documents. The author of a document is not involved in determining the form of the content on the web page, the placement of the document in the web site, or other details of content rendering. In an embodiment of the invention, the author may provide metadata 415 regarding the document to assist in searching and filtering of data in the generation of a web page. The content then is stored and managed in a database 420, thus making the content potentially available for web pages.

In one embodiment of the invention, the configuration of a web site 425 includes the creation of one or more templates 430 for the generation of web pages. More than one template may be used for a particular web page, and the type of template or templates used may vary depending on the type of page to be generated. In an embodiment of the invention, one or more matching rules are generated 435 to use in the filtering of data for the web pages. In the generation of a web page, the rules may determine such issues as the type of data, the age of data, the type of user authorized to see the page, and other such factors. A configuration file may be generated 440 to reflect the web site configuration requirements.

In one embodiment of the invention, content rendering 445 commences with the receipt of a request for a web page 450. Under an embodiment of the invention, the rendering of a page will be accomplished dynamically, with the structure and content of the web page varying depending on who requests the page and when the page is requested. A search is conducted for content for the web page based on the rules for the web site 455. The relevant content is pulled from the database resources 460 and is transformed using the appropriate template or templates 465. The dynamically generated web page then is delivered to the user 470.

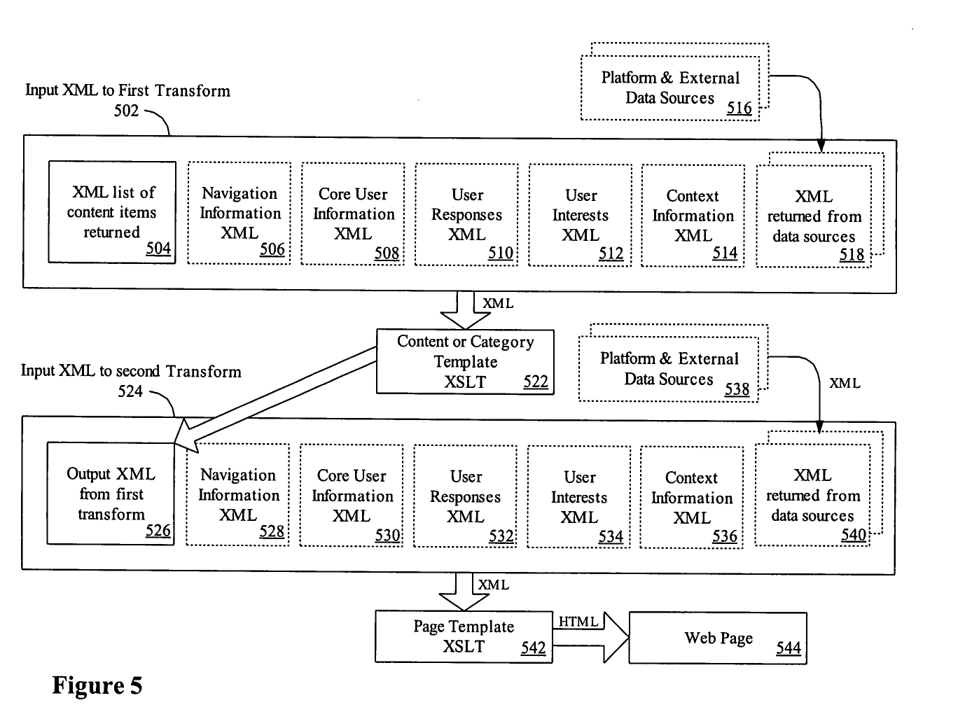

FIG. 5 illustrates an embodiment of the rendering of a web page. In this illustration, a web page is rendered using two transformations, although the number and ordering of transformations may vary depending on the particular embodiment of the invention. For the input of XML data to a first transformation 502, the data to be provided in the web page includes XML list of content items returned from a search for content 504. In addition, the data may include other types of data to generate the page, the data including navigation information data 506 (to provide general navigation in the web site), core user information 508 (for basic information to provided for the web site), data based on user responses 510, data relevant to certain user interests 512, and information regarding the current context 514. Further, returned data 518 may be received from platform sources or external data sources 516 if this is appropriate for a particular web page.

The combined input data 502 is provided to a first template 522, shown as a category or content template. The output from the first template 526 is then provided as part of input data for a second transform 524. The input data may again include navigation information data 528, core user information 530, data based on user responses 532, data relevant to user interests 534, information regarding the current context 536, and returned data 540 received from platform sources or external data sources 538. The combined input 524 is then provided to a second transform, shown as a page template 542, which then generates the requested web page 544.

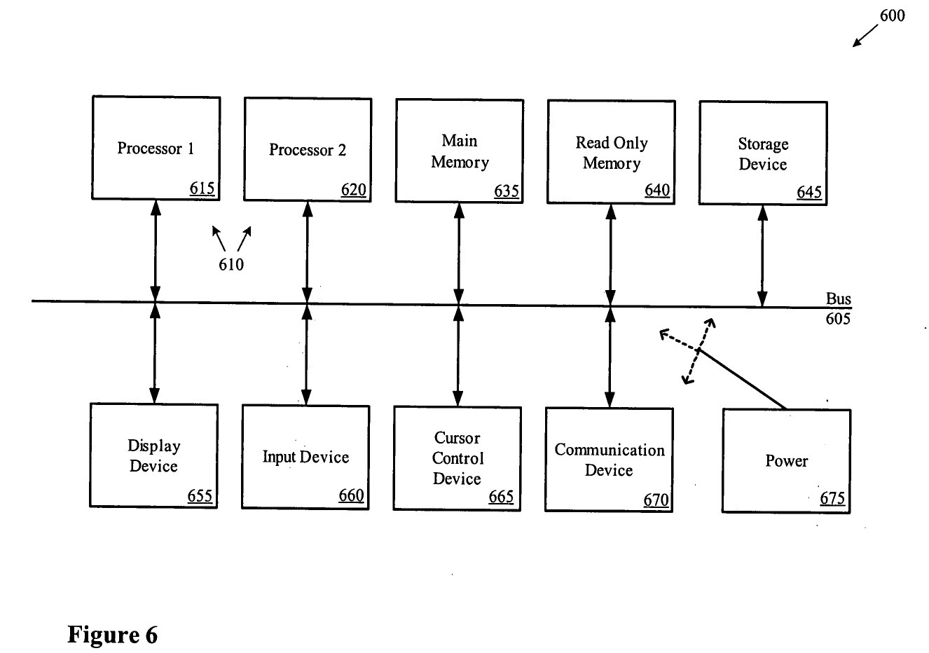

FIG. 6 is block diagram of an embodiment of a computer system, which may be used in conjunction with content delivery. Under an embodiment of the invention, a computer 600 comprises a bus 605 or other communication means for communicating information, and a processing means such as two or more processors 610 (shown as a first processor 615 and a second processor 620) coupled with the first bus 605 for processing information. The processors may comprise one or more physical processors and one or more logical processors.

The computer 600 further comprises a random access memory (RAM) or other dynamic storage device as a main memory 635 for storing information and instructions to be executed by the processors 610. Main memory 635 also may be used for storing temporary variables or other intermediate information during execution of instructions by the processors 610. The computer 600 also may comprise a read only memory (ROM) 640 and/or other static storage device for storing static information and instructions for the processors 610.

A data storage device 645 may also be coupled to the bus 605 of the computer 600 for storing information and instructions. The data storage device 645 may include a magnetic disk or optical disc and its corresponding drive, flash memory or other nonvolatile memory, or other memory device. Such elements may be combined together or may be separate components, and utilize parts of other elements of the computer 600.

The computer 600 may also be coupled via the bus 605 to a display device 655, such as a cathode ray tube (CRT) display, a liquid crystal display (LCD), or other display technology, for displaying information to an end user. In some environments, the display device may be a touch-screen that is also utilized as at least a part of an input device. In some environments, display device 655 may be or may include an auditory device, such as a speaker for providing auditory information. An input device 660 may be coupled to the bus 605 for communicating information and/or command selections to the processors 610. In various implementations, input device 660 may be a keyboard, a keypad, a touch-screen and stylus, a voice-activated system, or other input device, or combinations of such devices. Another type of user input device that may be included is a cursor control device 665, such as a mouse, a trackball, or cursor direction keys for communicating direction information and command selections to the one or more processors 610 and for controlling cursor movement on the display device 665.

A communication device 670 may also be coupled to the bus 605. Depending upon the particular implementation, the communication device 670 may include a transceiver, a wireless modem, a network interface card, or other interface device. The computer 600 may be linked to a network or to other devices using the communication device 670, which may include links to the Internet, a local area network, or another environment. The computer 600 may also comprise a power device or system 675, which may comprise a power supply, a battery, a solar cell, a fuel cell, or other system or device for providing or generating power. The power provided by the power device or system 675 may be distributed as required to elements of the computer 600.

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention may include various processes. The processes of the present invention may be performed by hardware components or may be embodied in machine-executable instructions, which may be used to cause a general-purpose or special-purpose processor or logic circuits programmed with the instructions to perform the processes. Alternatively, the processes may be performed by a combination of hardware and software.

Portions of the present invention may be provided as a computer program product, which may include a machine-readable medium having stored thereon instructions, which may be used to program a computer (or other electronic devices) to perform a process according to the present invention. The machine-readable medium may include, but is not limited to, floppy diskettes, optical disks, CD-ROMs (compact disk read-only memory), and magneto-optical disks, ROMs (read-only memory), RAMs (random access memory), EPROMs (erasable programmable read-only memory), EEPROMs (electrically-erasable programmable read-only memory), magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

Many of the methods are described in their most basic form, but processes can be added to or deleted from any of the methods and information can be added or subtracted from any of the described messages without departing from the basic scope of the present invention. It will be apparent to those skilled in the art that many further modifications and adaptations can be made. The particular embodiments are not provided to limit the invention but to illustrate it. The scope of the present invention is not to be determined by the specific examples provided above but only by the claims below.

It should also be appreciated that reference throughout this specification to “one embodiment” or “an embodiment” means that a particular feature may be included in the practice of the invention. Similarly, it should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims are hereby expressly incorporated into this description, with each claim standing on its own as a separate embodiment of this invention.

What is claimed is:

1. A method comprising:
establishing a matching rule for generation of a web page;
receiving a request for the web page;
obtaining content for the web page from a database, the content for the web page being based at least in part on the matching rule; and
generating the web page, the web page including the obtained content.

2. The method of claim 1, further comprising establishing a template for rendering the web page, wherein generating the web page comprises using the template to transform the content into the web page.

3. The method of claim 2, wherein generating the web page comprises accessing a site configuration file, the site configuration file comprising the matching rule and the template.

4. The method of claim 2, wherein the matching rule or the template may be modified without modifying the content in the database.

5. The method of claim 1, further comprising storing content in the database.

6. The method of claim 1, wherein storing content in the database comprises storing metadata regarding a document.

7. The method of claim 1, wherein the matching rule comprises one or more of a document type, a document subject, or a document date.

8. The method of claim 1, wherein the template comprises an XSLT (Extensible Stylesheet Language Transformation) transformation.

9. The method of claim 1, wherein the web page has a first area and a second area, the first area being transformed by a first template and the second area being transformed by a second template.

10. A content rendering engine comprising:
a set of matching rules, the matching rules to choose content for a web page from a database; and
a set of templates to generate the web page using the chosen content.

11. The content rendering engine of claim 10, wherein the set of matching rules and the set of templates are included in a site configuration file.

12. The content rendering engine of claim 10, wherein the matching rules match content based on metadata for the content.

13. The content rendering engine of claim 10, wherein the database is a part of a content management system, the content rendering engine operating independently from the content management system.

14. The content rendering engine of claim 10, wherein the content comprises XML (Extensible Mark-up Language).

15. The content rendering engine of claim 10, wherein the set of templates comprises a first template to generate a first type of web page and a second template to generate a second type of web page.

16. The content rendering engine of claim 16, wherein the set of templates further comprises a third template to generate both the first type of web page and the second type of web page.

17. The content rendering engine of claim 10, wherein the content rendering system is to generate the web page dynamically after receiving a request from a user for the web page.

18. The content rendering engine of claim 17, wherein the web page only displays content that the user is authorized to access.

19. A system comprising:
a web server;
a content management system, the content management system comprising a file storage, the file storage comprising content for a web site; and
a content rendering system, the content rendering system comprising a site configuration file to generate web pages using content from the content management system.

20. The system of claim 19, wherein the site configuration file comprises a matching rule to match content for a web page from the file storage.

21. The system of claim 20, wherein the site configuration file comprises a template to generate a web page.

22. The system of claim 21, wherein the template transforms XML (Extensible Mark-up Language) data into a web page.

23. The system of claim 19, further comprising a connection to a user, the user requesting a web page.

24. The system of claim 19, wherein the content rendering system operates independently from the content management system.

25. A machine-readable medium having stored thereon data representing sequences of instructions that, when executed by a processor, cause the processor to perform operations comprising:
establishing a matching rule for generation of a web page;
establishing a template for rendering the web page;
receiving a request for the web page;
searching for documents to be presented in the web page using the matching rule;
combining data for the web page; and
transforming the data into the web page.

26. The medium of claim 25, wherein searching for documents comprises searching metadata that describes stored documents.

27. The medium of claim 25, wherein the combined data includes data from a content management system.

28. The medium of claim 27, wherein the combined data further comprises data from external data sources.

29. The medium of claim 28, wherein combined data is converted into HTML (Hypertext Markup Language) data.
